(19) United States
(12) Patent Application Publication
(10) Pub. No.: US 2003/0037451 A1
(43) Pub. Date: Feb. 27, 2003

(54) Vehicle frame measuring device

(76) Inventor: Alan J. Sarauer, Chippewa Falls, WI (US)

Correspondence Address: Allan O. Maki, RYAN KROMHOLZ & MANION, S.C., Post Office Box 26618, Milwaukee, WI, 53226-0618, US

(21) Appl. No.: 09/939,970

(22) Filed: Aug. 27, 2001

(51) Int. Cl. G01B 5/008

(52) U.S. Cl. 33/608; 33/503

(57) ABSTRACT

A coordinate measuring machine has a horizontal rail defining an X-axis, a vertical rail movable along the horizontal rail defining a Z-axis, and a horizontal arm orthogonally situated relative to said X and Z axis defining a Y axis. Pairs of opposed track surfaces integral with the rails are engaged by pairs of wheels for rolling movement of the axes relative to each other. Biasing means such as coil springs urge the wheels of each of the pairs into contact with the opposed track surfaces in order to accurately maintain desired orthogonal relationships between the axes.

### TECHNICAL FIELD

This invention relates to coordinate measuring machines. More specifically, the invention relates to an improved coordinate measuring system especially adaptable for auto body repair.

### BACKGROUND OF THE INVENTION

Coordinate measuring machines are used for measurement of auto bodies during repair as described in my U.S. Pat. Nos. 4,683,663 and 5,621,978. Such devices have also been used for dimensional inspection of work pieces such as models or machine parts, for example, in preparation of new product mock-up models or for measurement of machine parts during manufacturing operations. Such devices have been used in producing molds, dies, and fixtures from blueprints or CAD/CAM data with a high degree of accuracy.

The devices shown in my above-mentioned patents have proved successful in practice. However, a need has existed for improvements of the devices particularly as to retention of the desired angular positioning of measurement arms if subjected to incidental impact during use or after extended periods of wear.

### SUMMARY OF THE INVENTION

In accordance with the present invention, an improved coordinate measuring device is provided. In accordance with an important aspect of the invention, the configurations illustrated in my earlier patents are modified to introduce biasing of the measurement arm supporting wheels which support and permit movement of the coordinate arms along supporting rails. As a result, the supported measuring arms are resiliently urged into firm contact with the surfaces upon which they travel.

In accordance with a further aspect of the invention, the biasing forces are provided by a simple device such as a compression spring. In accordance, a further related aspect of the preferred biasing device is a coiled metal spring of commonly available configuration.

In accordance with the invention, a coordinate measuring device especially adaptable for use of auto body repair is provided which is imparted with improved dimensional stability. In accordance with yet a further aspect, if flexing of the measuring arms occurred, the biasing forcing provided in accordance with the invention insure return of the arms to their desired original position.

Briefly, the invention provides a coordinate measuring machine which has a horizontal rail defining an X-axis, a vertical rail movable along the horizontal rail defining a Z-axis, and a horizontal arm orthogonally situated relative to said X and Z axis defining a Y axis. Pairs of opposed track surfaces integral with the rails are engaged by pairs of wheels for rolling movement of the axes relative to each other. Biasing means such as coil springs urge the wheels of each of the pairs into contact with the opposed track surfaces in order to accurately maintain desired orthogonal relationships between the axes.

Further objects, advantages and aspects of the invention will be apparent from the following detailed description and accompanying drawings wherein:

### DESCRIPTION OF THE DRAWINGS

FIG. 1 is an isometric view, with parts cut away and shown in cross-section of a coordinate measuring device of the present invention;

FIG. 2 is a side elevational view of a coordinate-measuring machine of the present invention;

FIG. 3 is an enlarged cross-sectional view taken through a measuring arm and supporting rail of the device of FIG. 2; and,

FIG. 4 is a fragmentary elevational view with parts broken away to show interior details taken along line 4-4 of FIG. 3.

### DETAILED DESCRIPTION OF THE INVENTION

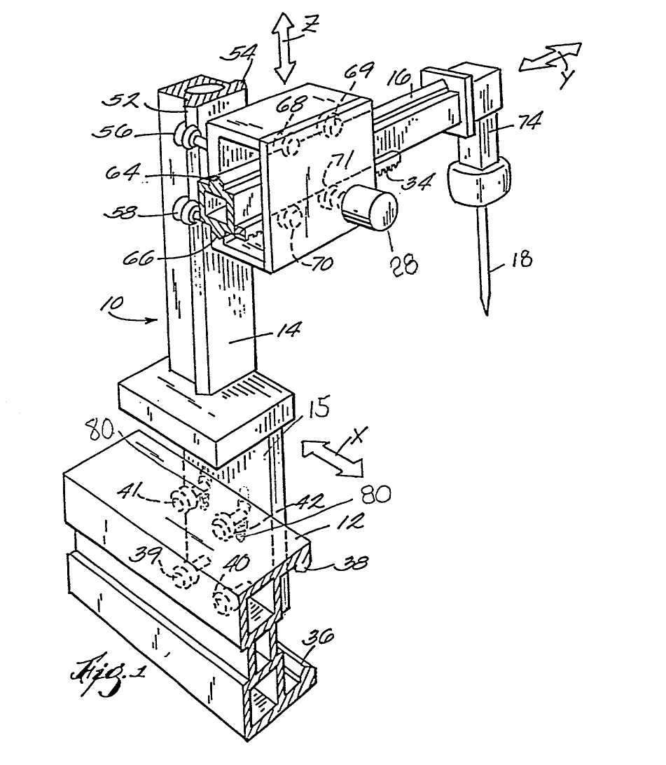

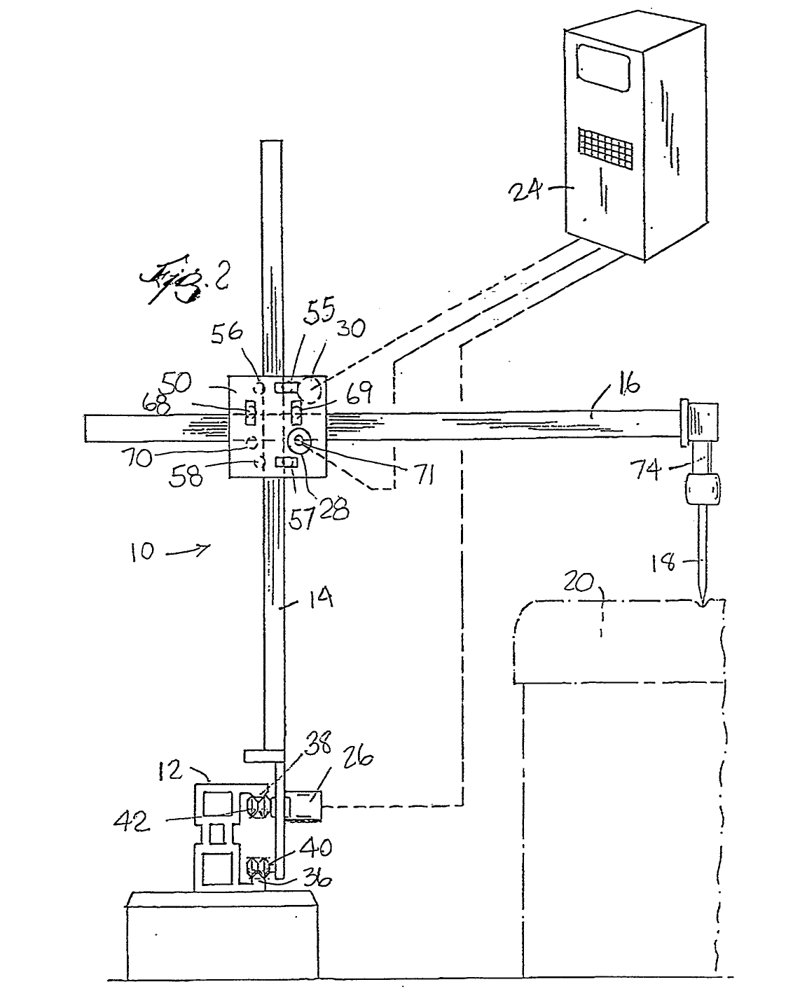

Referring more specifically to the drawings, a coordinate measuring machine is indicated generally by numeral 10. As best seen in FIGS. 1 and 2, a horizontal rail 12 if provided in order to permit movement in the X direction.

A vertical rail 14 is provided in order to allow movement of the device in the Z direction. A horizontal rail 16 is orthogonally oriented relative to rails 12 and 14 and is provided for movement of the device in the Y direction. A pointer 18 is usually positioned on the distal end of rail 16 in order to locate a point on a work piece indicated by phantom lines and by numeral 20.

The position of each of arms 14 and 16 relative to a starting point can be indicated by means of linear position marking provided along each of the arms, is desired. They can also be indicated by means of extendable-retractable measuring tapes as described in my U.S. Pat. No. 4,683,663. However, as disclosed in my subsequent U.S. Pat. No. 5,621,978, the positions are preferably determined using a microprocessor 24 to which electronic signals are provided by encoding devices 26, 28 and 30 located on each of the axes of the coordinate measuring machine. Further details regarding the encoding devices are described and shown in my U.S. Pat. No. 5,621,978, the disclosure of which is incorporated herein by reference.

As seen in FIGS. 1 and 2, rail 12 which defines the X axis is horizontally positioned and is provided with a pair of V-shaped convex projecting surfaces 36 and 38. The convex surfaces 36 and 38 are engaged by two or more pairs of lower and upper supporting wheels 39, 41 and 40, 42. These pairs of wheels provide a means for supporting the vertical arm 14 for easy rolling movement along the X-axis defined by rail 12. An encoder 26 transmits electrical signals to a microprocessor 24 for the purpose of providing readings which indicate the precise position of the coordinate measuring device along the X-axis.

A support housing 50 is provided with pairs of wheels 55, 56 and 57, 58 which enable rolling movement upwardly and downwardly of the housing 50, and arm 16 supported thereby, along the Z axis defined by vertical rail 14.

Vertical rail 14 is provided with convex surfaces 52 and 54 on its opposite sides. The surfaces 52 and 54 are engaged by concavely surfaced wheels 56, 58 and 55, 57 rotably mounted to the housing 50 on opposite sides of rail 14. Housing 50 can be counter balanced by means of a weight located within vertical arm 14 in the same manner in my U.S. Pat. No. 4,683,663, the disclosure of which is incorporated by reference. Housing 50 can, thus, be easily moved up and down along vertical arm 14 and will stay in selected positions thereon.

Rail 16 is provided with projecting convex surfaces 64 and 66 which provide tracts along its upper and lower surfaces. In the preferred embodiment, the projecting convex surfaces extend centrally along arm 16. Pairs of concavely surfaced wheels 68, 69 and 70, 71 engage the upper and lower convex surfaces 64 and 66, respectively. The mounting device 74 of conventional design secures pointer 18 to the distal end of arm 16. Mounting device 74 can either be of a stationary type or an extendable-retractable type driven by a servo motor if desired. In the preferred embodiment, rails 12, 14 and 16 are all formed of extruded and anodized aluminum. Such shape can accurately be machined to form the projecting concave track surfaces 64, 66, or 36, 38, or 52, 54.

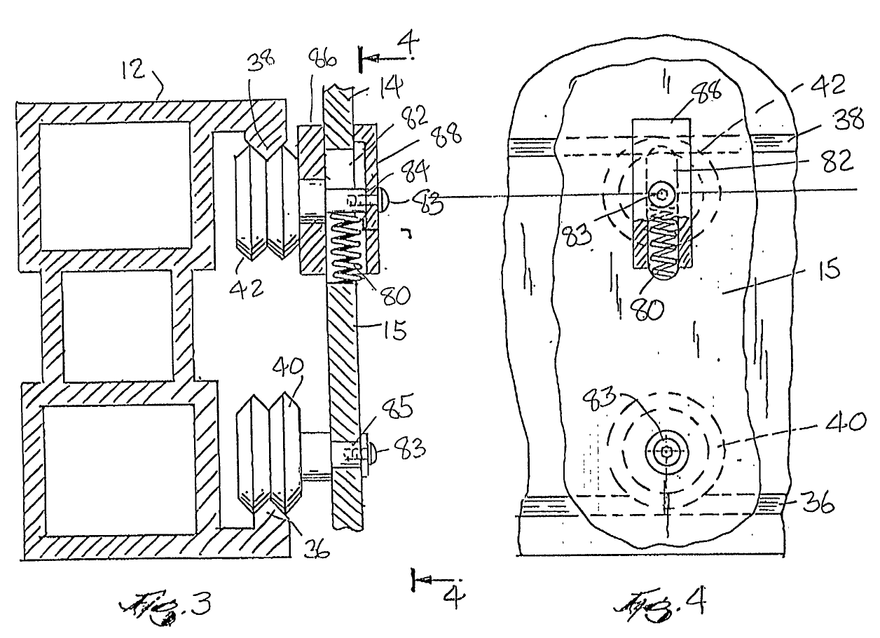

Referring the FIGS. 3 and 4, it will be seen that the pairs of wheels 40 and 42 are biased into firm engagement with the convex tract members 36 and 38 by means of a biasing spring 80. Spring 80 is fitted in a slot 82 formed in a plate 15 which supports vertical arm 14. Spring 80 in its preferred form is a coiled compression spring as shown and is positioned between the lower end of slot 82 and a shaft 84 which supports wheel 42. A bolt 83 tapped threaded into a central opening in the end of shaft 84 holds the assembly together. A similar shaft 85 holds the wheel 40 in position on plate 15. Rectangular plates 86 and 88 serve as washers to enclose the opposite sides of the slot 82 and thereby retain the spring 80 in its desired position. By virtue of the forces biasing the wheels 40 and 46 away from each other, the supporting wheels firmly engage the convex rails 36 and 38. Notably, in the event tilting forces are inadvertently applied against the vertical support 14, the biasing forces supplied by springs 80 will tend to return the vertical member 14 to its precise vertical orientation. A similar spring 80 is also provided to bias the second pair of wheels 39, 41 away from each other so that they are also urged into firm contact with tracks 36 and 38.

Similar springs can be provided within slots formed in housing 50 in order to bias the wheels 55 and 57 into engagement with tracks 54. Also similar springs may be employed to bias the pairs of wheels 68, 70 and 69,71 into firm engagement with tracks 64 and 66. It will be understood, that, if desired, the device can be configured so that only one or two of the X, Y or Z axes are provided with biasing forces. However, in order to produce a device having optimum accuracy, all three axes can be provided with biasing forces as shown.

Also seen in FIG. 1 is a toothed track 34 used for accurate engagement of a toothed wheel connected to encoder 28 in order to achieve accurate position readings for the device. Similar tracks can be provided for engagement of similar wheels connected to encoders 26 and 30.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

What is claimed is:

1. A coordinate measuring machine having a horizontal rail defining an X-axis, a vertical rail movable along the horizontal rail defining a Z-axis, and a horizontal arm orthogonally situated relative to said X and Z axis defining a Y axis,
a pair of opposed track surfaces integral with said X-axis horizontal rail;
said vertical rail being supported by a plurality of pairs of wheels, one wheel of each of said pairs engaging one of said opposed track surfaces, and
biasing means urging the wheels of each of said pairs into contact with said opposed track surfaces.

2. A machine according to claim 1 wherein each of said tracks is formed by a rail having a V-shaped convex surface and each of said wheels has a mating concave surface adapted to roll along said rail.

3. A machine according to claim 1 wherein said biasing means comprises a compression spring and said wheel is supported by a shaft bearing against said spring.

4. A machine to claim 3 wherein said compression spring is positioned in a slot formed in a member through which said shaft extends.

5. A machine according to claim 1 wherein a pair of opposed track surfaces are integral with said Z-axis vertical rail;
said Y-axis horizontal rail being supported by a plurality of pairs of wheels, one wheel of each of said pairs engaging one of said opposed Z-axis track surfaces, and
biasing means urging the wheels of each of said pairs into contact with said opposed Z-axis track surfaces.

6. A machine according to claim 5 wherein a pair of opposed track surfaces are integral with said Y-axis horizontal rail;
said Y-axis horizontal rail being supported by a plurality of pairs of wheels, one wheel of each of said pairs engaging one of said opposed Y-axis track surfaces, and
biasing means urging the wheels of each of said pairs into contact with said opposed Y-axis track surfaces.

7. A machine according to claim 6 wherein each of said biasing means comprises a coil spring.

8. A coordinate measuring machine having a horizontal rail defining an X-axis, a vertical rail movable along the horizontal rail defining a Z-axis, and a horizontal arm orthogonally situated relative to said X and Z axis defining a Y axis,
a pair of opposed track surfaces integral with said X-axis horizontal rail;
said vertical rail being supported by a plurality of pairs of wheels, one wheel of each of said pairs engaging one of said opposed track surfaces, and
one wheel of each of said pairs being supported by an axle mounted through an elongated opening in a supporting plate affixed to said vertical rail, a spring in said opening having an end engaging said axle and urging the wheel supported by said axle into contact with said opposed track surface.

9. A machine according to claim 8 wherein a pair of opposed track surfaces are integral with said Z-axis vertical rail;
said Y-axis horizontal rail being supported by a plurality of pairs of wheels, one wheel of each of said pairs engaging one of said opposed Z-axis track surfaces, and
a biasing spring urging the wheels of each of said pairs into contact with said opposed Z-axis track surfaces.
